(19) United States
(12) Patent Application Publication
(10) Pub. No.: US 2025/0284827 A1
(43) Pub. Date: Sep. 11, 2025

(54) SYSTEMS AND METHODS FOR PRE-CHECKING DATA TRANSFERS

(71) Applicant: The Toronto-Dominion Bank, Toronto (CA)

(72) Inventors: Hitesh BAJAJ, Duluth, GA (US); Milos DUNJIC, Oakville (CA); David Samuel TAX, Toronto (CA); Jonathan Joseph PRENDERGAST, West Chester, PA (US); Mohit SHARMA, Toronto (CA); Abhijit SINGHA HAZARI, Oakville (CA); Pranay GUPTA, Toronto (CA); Kushank RASTOGI, Toronto (CA); Thomas KELLY, Wenonah, NJ (US)

(73) Assignee: The Toronto-Dominion Bank, Toronto (CA)

(21) Appl. No.: 18/601,309

(22) Filed: Mar. 11, 2024

(51) Int. Cl. G06F 21/60

(52) U.S. Cl. CPC G06F 21/606

(57) ABSTRACT

The present disclosure relates to systems and methods for pre-checking transfer information for data transfers using trained machined learning models. There is provided a computer system, comprising a processor; a communications module coupled to the processor; and a memory coupled to the processor. The memory stores instructions that, when executed, configure the processor to monitor input of transfer input for a data transfer in an input field of an interface displayed on a device in real-time, determine a format protocol that applies to the input field, determine whether the transfer input complies with the format protocol using a trained machine learning model, generate and transmit a signal to the device receiving the transfer input in real time, the signal indicating whether the transfer input complies with the format protocol, and receive modification to the transfer input in the input field prior to execution of the data transfer.

### TECHNICAL FIELD

The present application relates to data transfers and, more particularly, to systems and methods for pre-checking or pre-validating data transfers.

### BACKGROUND

Data transfers between individuals and/or institutions can often fail when recipient information is entered incorrectly. In many cases, the recipient information required may be long and highly specific, making failed data transfers a common occurrence. For example, if a transfer is to be sent to an institution in a foreign country, the target number may be, among other features, over twenty characters long. Given the often unintuitive nature of recipient address information, the user may have to make multiple attempts at the data transfer before the data transfer is successful.

Meanwhile, machine learning (ML) models, including generative artificial intelligence (GenAI), are capable generating text, images, and other media from generative artificial intelligence models such as large language models, multi-modal large language models, neural networks, and the like. A GenAI model can learn patterns and structure of the training data input to the GenAI model during training, and then use what is learned during the training to generate new data with similar characteristics.

### BRIEF DESCRIPTION OF THE DRAWINGS

Embodiments are described in detail below, with reference to the following drawings:

FIG. 1 is a schematic operations diagram illustrating an operating environment of a system according to an example embodiment of the present disclosure;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3; and

FIG. 5 is a schematic diagram illustrating a generative artificial intelligence (GenAI) computing environment of the computer system of FIG. 1 according to example embodiments;

FIG. 6 is a diagram illustrating processes for training a machine learning model according to example embodiments; and

FIG. 7 is a flowchart showing operations performed by the computer system of FIG. 5 for pre-checking data transfers according to example embodiments.

Like reference numerals are used in the drawings to denote like elements and features.

### DETAILED DESCRIPTION

In one aspect of the present disclosure, there is provided a computer system, comprising: a processor; a communications module coupled to the processor; and a memory coupled to the processor, the memory storing instructions that, when executed, configure the processor to: monitor input of transfer input for a data transfer in an input field of an interface displayed on a device in real-time; determine a format protocol that applies to the input field; determine whether the transfer input complies with the format protocol using a trained machine learning model; generate and transmit a signal to the device receiving the transfer input in real time, the signal indicating whether the input complies with the format protocol; and receive modification to the transfer input in the input field prior to execution of the data transfer.

In some implementations, the instructions further configure the processor to convert the transfer input into transfer text input.

In some implementations, the instructions further configure the processor to identify one or more aspects of the transfer text input that do not comply with the format protocol using the trained machine learning model; wherein the signal incorporates the one or more aspects of the transfer text input that do not comply with the format protocol.

In some implementations, the format protocol relates to aspects of the transfer text input including a required number of characters in the transfer text input, and whether each character is a letter, a number, or a non-alphanumeric symbol.

In some implementations, the instructions further configure the processor to determine the format protocol that applies to the input field by: receiving another input from another input field of the interface, the other input indicating the format protocol.

In some implementations, the format protocol is determined from a plurality of format protocols.

In some implementations, each format protocol is associated with a country, and the instructions, when executed, further configure the processor to determine the format protocol by determining the country the other input is affiliated with.

In some implementations, the trained machine learning model is a generative artificial intelligence (GenAI) model.

In some implementations, the instructions further configure the processor, upon execution of the GenAI model, to obtain an output explaining why the one or more aspects of the transfer text input do not comply with the format protocol; wherein the signal includes the output.

In some implementations, the GenAI model is a large language model (LLM), and the output further comprises one or more suggestions of how the one or more aspects of the transfer text input may be modified to help comply with the format protocol.

In some implementations, the instructions further configure the processor to transmit the signal with the output to the device via an email.

In some implementations, the instructions further configure the processor to receive an indication for further information regarding the one or more aspects of the transfer text input that do not comply with the format protocol; obtain, upon execution of the GenAI model, an output explaining why the one or more aspects of the transfer text input do not comply with the format protocol; and transmit the output to the device in response to the indication.

In another aspect of the present disclosure, there is provided a method comprising: monitoring input of transfer input for a data transfer in an input field of an interface displayed on a device in real-time; determining a format protocol that applies to the input field; determining whether the transfer input complies with the format protocol using a trained machine learning model; generating and transmitting a signal to the device receiving the transfer input in real time, the signal indicating whether the transfer input complies with the format protocol; and receiving modification to the transfer input in the input field prior to execution of the data transfer.

In some implementations, the method further comprises identifying one or more aspects of the transfer input that do not comply with the format protocol using the trained machine learning model; wherein the signal incorporates the one or more aspects of the transfer input that do not comply with the format protocol.

In some implementations, the transfer input is transfer text input and the format protocol relates to aspects of the transfer text input including a required number of characters in the transfer text input, and whether each character is a letter, a number, or a non-alphanumeric symbol.

In some implementations, determining the format protocol that applies to the input field comprises: receiving another input from another input field of the interface, the other input indicating the format protocol.

In some implementations, the trained machine learning model is a generative artificial intelligence (GenAI) model.

In some implementations, the method further comprises, upon execution of the GenAI model, obtaining an output explaining why the one or more aspects of the transfer input do not comply with the format protocol; wherein the signal includes the output.

In some implementations, the method further comprises, upon execution of the GenAI model, obtaining an output comprising one or more suggestions of how the one or more aspects of the transfer input may be modified to help comply with the format protocol.

In another aspect of the present disclosure, there is provided a computer-readable medium comprising instructions stored therein which, when executed by a processor, cause a computer to: monitor input of transfer input for a data transfer in an input field of an interface displayed on a device in real-time; determine a format protocol that applies to the input field; determine whether the transfer input complies with the format protocol using a trained machine learning model; generate and transmit a signal to the device receiving the transfer input in real time, the signal indicating whether the transfer input complies with the format protocol; and receive modification to the transfer input in the input field prior to execution of the data transfer.

The present subject matter uses trained machine learning models, including generative AI, to monitor and determine whether a data transfer is likely to be successful based on the content and format of the inputted transfer information or transfer input. For example, the data transfer may be a payment transfer and the transfer input may include the name and bank account number of the recipient. However, the data transfer may fail if the format of, or other information relating to, the transfer input is incorrect. For example, bank account numbers may be long, highly specific, and unintuitive. The present systems and methods can be used to help notify a user in real time whether the data transfer is likely to succeed or fail due to the inputted transfer information or input, and thereby help to reduce the computing processing resources that would otherwise be required when, potentially multiple, transfers are attempted after a failed data transfer.

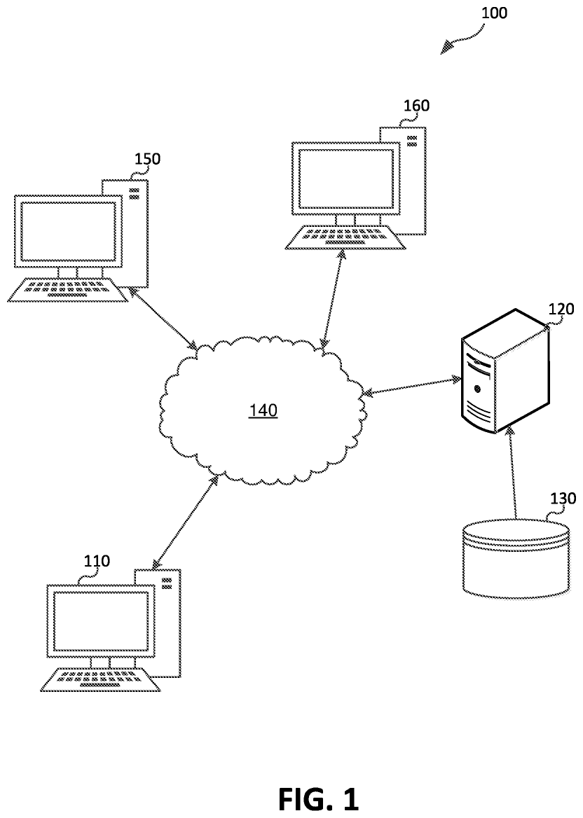

FIG. 1 is a schematic operation diagram illustrating an operating environment of an example embodiment. As shown, the system 100 includes a client device 110 and a computer system 120 with a database 130, coupled to one another through a network 140, which may include a public network such as the Internet and/or a private network. The client device 110 and the computer system 120 may be in the same location or geographically disparate locations. In other words, the client device 110 and the computer system 120 may be located remote from one another. The system 100 may further include other client devices 150 and 160, which may also be coupled the computer system 120 through the network 140.

The client device 110 may be a personal computer as shown in FIG. 1. However, the client device 110 may be a computing device of another type such as for example a smartphone, a laptop, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The client device 110 may be associated with an entity, such as a user or client.

The computer system 120 may be, for example, a mainframe computer, a minicomputer, or the like. In some embodiments thereof, a computer system may be formed of or may include one or more computing devices. The computer system 120 may include and/or may communicate with multiple computing devices such as, for example, one or more database servers (including a database 130), computer servers, and the like. Multiple computing devices such as these may be in communication using a computer network and may communicate to act in cooperation as a computer server system. For example, the computing devices may communicate using a local-area network (LAN). In some embodiments, the computer system 120 may include multiple computing devices organized in a tiered arrangement. For example, the computer system 120 may include middle tier and back-end computing devices. In some embodiments, the computer system 120 may be a cluster formed of a plurality of interoperating computing devices.

The computer system 120 may be associated with or used by one of various institutions. In some embodiments, the computer system 120 may be associated with a financial institution and, to that end, may maintain records of customer financial accounts and associated financial data in the database 130. The database 130 may be provided internally within the computer system 120 or externally. To that end, the database 130 may be provided remotely from the computer system 120. For example, the database 130 may be stored in one or more data centers, and the data centers may store data with bank-grade security. The client device 110 may, thus, be associated with a customer having a financial account with the financial institution. The other client devices 150, 160 may also be associated with other customers having financial accounts with the financial institution, or may be associated with other (financial) institutions.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the system 100 may be a cloud-based system. For example, the computer system 120 may itself be virtual and the various components and modules thereof may be resident on the cloud. The computer system 120 may include one or more virtual machines or virtual processors that may be accessed via the cloud.

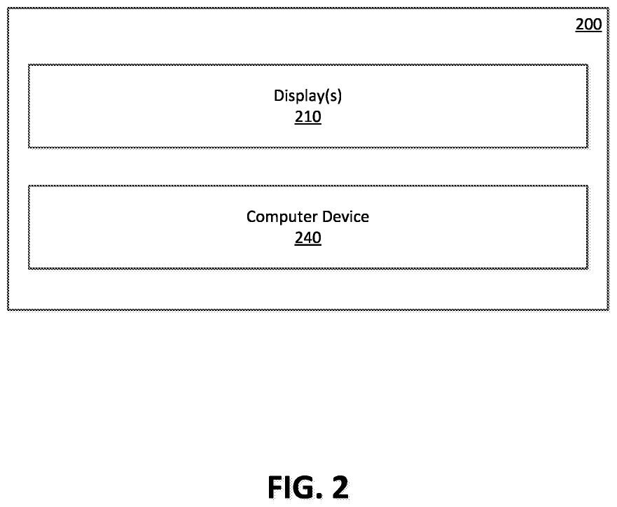

FIG. 2 is a simplified schematic diagram showing components of an exemplary computing device 200, such as the client device 110, 150, 160. The exemplary computing device 200 may include modules including, as illustrated, for example, one or more displays 210 and a computer device 240.

The one or more displays 210 are a display module. The one or more displays 210 are used to display screens of a graphical user interface that may be used, for example, to communicate with the computer system 120. The one or more displays 210 may be internal displays of the exemplary computing device 200 (e.g., disposed within a body of the computing device).

The computer device 240 is in communication with the one or more displays 210. The computer device 240 may be or may include a processor which is coupled to the one or more displays 210.

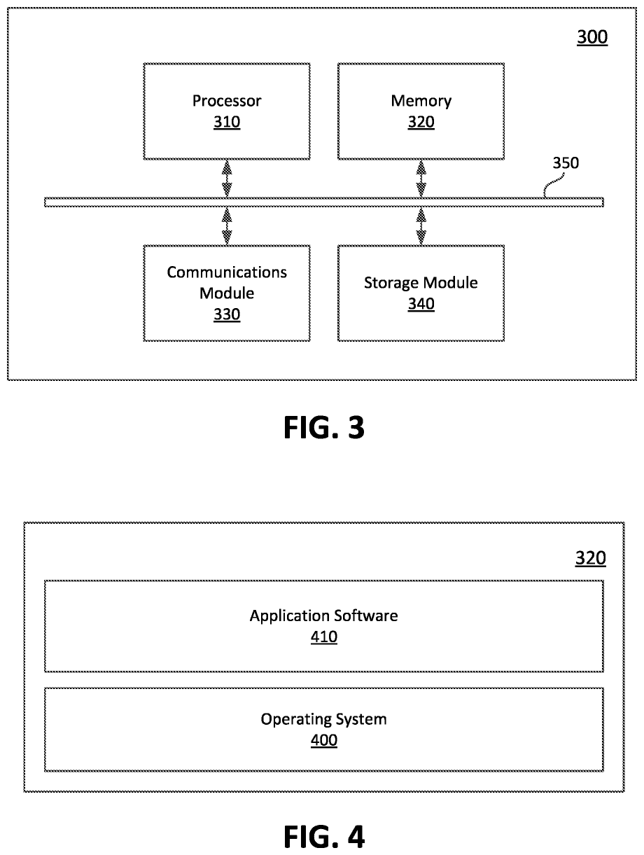

Referring now to FIG. 3, a high-level operation diagram of an example computer system 300 is shown. In some embodiments, the example computing system 300 may be exemplary of the computer system 120 and/or the client devices 110, 150, 160 (shown in FIG. 1). The example computer system 300 includes a variety of modules. For example, the example computer system 300 may include at least one processor 310, a memory 320, a communications module 330, and/or a storage module 340. As illustrated, the foregoing example modules of the example computer system 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computer or computing devices and/or various communications networks. For example, the communications module 330 may allow the example computer system 300 to send or receive communications signals to/from the client devices 110, 150, 160 over the network 140. Communications signals may be sent or received according to one or more protocols or according to one or more standards. For example, the communications module 330 may allow the example computing system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing system 300 to communicate using near-field communication (NFC), via Wi-Fi™, using Bluetooth™ or via some combination of one or more networks or protocols. In some embodiments, all or a portion of the communications module 330 may be integrated into a component of the example computing system 300. For example, the communications module 330 may be integrated into a communications chipset. In some embodiments, the communications module 330 may be omitted such as, for example, if sending and receiving communications is not required in a particular application.

The storage module 340 allows the example computing system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as the database 130, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing system 300 (FIG. 3). As illustrated, these software components include an operating system 400 and an application 410.

The operating system 400 is software. The operating system 400 allows the application 410 to access the at least one processor 310, the memory 320, and the communications module 330 of the example computing system 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing system 300, in combination with the operating system 400, to operate as a device performing a particular function. For example, the application 410 may cooperate with the operating system 400 to adapt a suitable embodiment of the example computing system 300 to operate as the computing system 120 and/or the client devices 110, 150, 160 (from FIG. 1).

While a single application 410 is illustrated in FIG. 4, in operation, the memory 320 may include more than one application 410 and different applications may perform different operations. For example, in at least some embodiments in which the example computing system 300 is functioning as the client device 110, 150, 160, the applications 410 may include an application for displaying a graphical user interface associated with sending an application programming interface request. The computer system 120 may be configured to receive application programming interface requests and may perform operations to respond thereto.

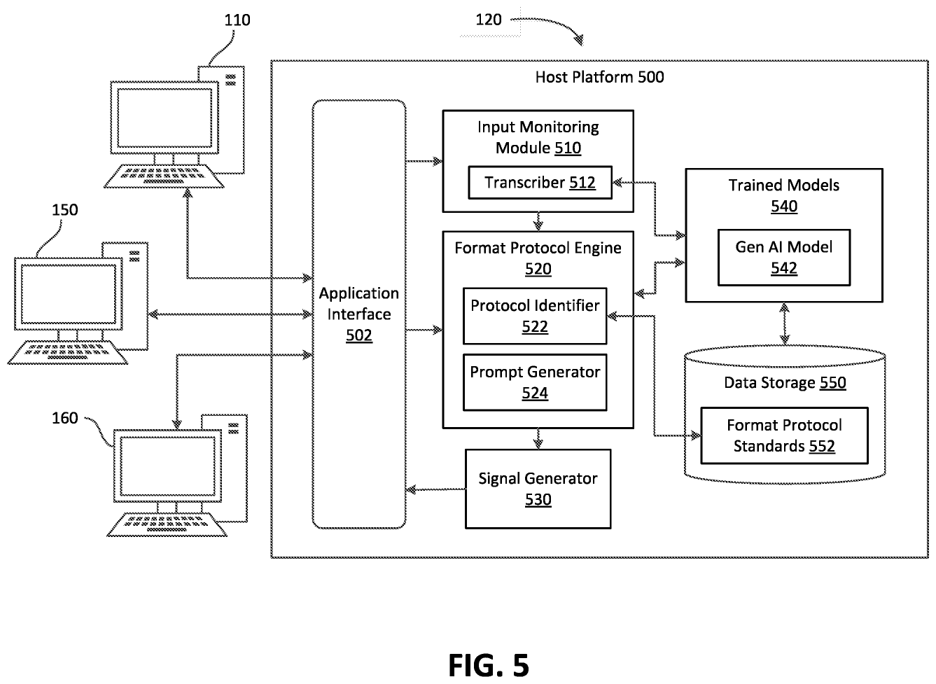

FIG. 5 is a simplified schematic diagram showing components of a host platform 500 of the computer system 120 in greater detail. The computer system 120 may store computer-executable instructions in the memory 320, which may be executed by a processing unit such as the processor 310, to implement one or more embodiments disclosed herein. The depicted example embodiments are directed to the computer system 120 that hosts the host platform 500 that uses trained machine learning (ML) models, which may include generative artificial intelligence (GenAI), to monitor and pre-check transfer input to help increase the likelihood of a successful data transfer.

The host platform 500 may receive transfer input from a user, such as a client, customer, or other institution through client devices 110, 150, 160, where the transfer input may be a text input, a document, or speech that is then converted into text and the like, and respond with an answer to the input. Here, one or more trained ML models, including a generative artificial intelligence (GenAI) model, may receive the input from the user and generate an answer based on its/their training. The response may include text-based content, an image, a combination thereof, and the like.

The memory 320 of the computer system 120 may store instructions for implementing software applications hosted by the host platform 500, including an application interface 502, an input monitoring module 510, a format protocol engine 520, a signal generator 530, trained models 540, and data storage 550.

In the depicted example, the host platform 500 may be a cloud platform, web server, etc., that hosts software applications and other software programs that are hosted and made available on the Internet to the client devices 110, 150, 160. The software may be accessed via a URL, mobile application, etc. In other examples, the input monitoring module 510, the format protocol engine 520, and the signal generator 530 may reside in the memory 320 of the client devices 110, 150, 160, while the trained models 540 and/or the data storage 550 may reside in the memory 320 of the computer system 120. Other variations are possible.

The application interface 502 may act as a software intermediary that allows an application executing on the client device 110, 150, 160 to communicate with an application executing on the computer system 120. The application interface 502 may allow the client device 110 to request data and may enable the computer system 120 to obtain and provide the requested data to the client device 110.

The application interface 502 may be configured to receive application programming interface requests that define parameters. The application interface 502 may perform operations to obtain data to fulfill the application programming interface requests.

In one or more embodiments, the application interface 502 may include a representational state transfer (REST) application programming interface. The REST application programming interface may utilize Hypertext Transfer Protocol (HTTP) methods (e.g. GET, POST) to receive and respond to application programming interface requests. The REST application programming interface may obtain data according to application programming interface requests and may return fixed data sets as a response to the application programming interface requests.

In one or more embodiments, the application interface 502 may include a GraphQL application programming interface. The GraphQL application programming interface may be hierarchical. The GraphQL application programming interface may obtain data according to application programming interface requests without under fetching or over fetching data.

The application interface 502 may include both the REST application programming interface and the GraphQL schemas and may perform operations to select one of the REST and GraphQl application programming interfaces. In one or more embodiments, the computer system 120 may receive an application programming interface request in a format compliant with one of the application programming interface schemas and may translate the request into another format.

When initiating a data transfer, a user must input transfer information, data, or input, including to whom and where the data is to be transferred to. For example, in applications where the data transfer is a payment transfer, the transfer input may include the recipient's name and bank details, including the recipient's bank account number. Thus, the input monitoring module 510 comprises instructions to the processor 310 to monitor input of the input, such as the transfer input for the data transfer, in an input field in real-time. The transfer input may be inputted via the graphical user interface on the one or more displays 210 of the client device 110. The transfer input may be inputted as input in text form, audio form, or another known forms of input.

The input monitoring module 510 may comprise instructions to the processor 310 to determine that transfer input has been inputted into the input field, and also to identify the form of the transfer input that has been inputted in real-time. For example, if the transfer input is not in text form, the input monitoring module 510 may further comprise instructions to the processor 310 to convert the non-text input (such as audio input) into transfer text input. To that end, the input monitoring module 510 may comprise a transcriber 512. The transcriber 512 may be a speech-to-text application as known in the art that is configured to automatically convert the audio input into a text format. The transcriber 512 may be a software tool and/or a machine learning model trained to convert audio into text in real time.

Depending on the application and purpose, the transfer input may have a pre-established set of standards or protocols, referred to herein as format protocols, that must be followed in order for the transfer input to be deemed correct and for the transfer to be successful. The format protocols are standards relating to the content, arrangement, and/or other formatting of the transfer information/input. For example, for transfer input in text form, the content, arrangement, and other formatting may include parameters such as the required number of characters, which characters must be numbers, if/where particular numbers must be positioned in the series, whether particular characters are letters or non-alphanumeric symbols, where certain characters are grouped in a particular arrangement etc. In applications involving payment transfers, a bank account number typically involves a long series of numbers, and possibly letters and other characters. Their content, arrangement, and other formatting are pre-established based on international banking regulations. Each country typically has one (or more) unique format protocols for their bank account numbers that must be followed for payments to be transferred to a particular bank account in that country. In many cases, the transfer input that is inputted must correctly follow its applicable format protocol for the data transfer to be successful. Otherwise, the data transfer may fail and not go through.

The format protocol engine 520, thus, comprises a protocol identifier 522 that has instructions to the processor 310 to determine a format protocol that corresponds with, or is to be applied to, the input field (for the transfer input) of the user interface. The applicable format protocol may be identified from a plurality of possible format protocols, such as from the plurality of format protocols established for banking institutions around the world. The plurality of format protocols, and their specific requirements, may be stored in the data storage 550 as format protocol standards 552. While the data storage 550 may reside in the memory 320 of the computer system 120, the data storage 550 may alternatively be stored remotely from the host platform 500, and accessed as required.

To determine which format protocol applies to the input field, the protocol identifier 522 may have instructions to the processor 310 to receiving another input from another input field of the user interface, where the other input indicates which format protocol applies to the input field for the transfer input. The other input field may be a text input field, where the protocol identifier 522 has instructions to the processor 310 to associate the other input with one of the plurality of format protocols to identify the applicable format protocol. In the payment transfer example, each of the plurality of format protocols may be associated with a particular country. Thus, if “NZ”, “New Zealand”, or some variation is inputted into the other input field, the protocol identifier 522 has instructions to the processor 310 to identify the format protocol (for bank account numbers) associated with New Zealand. In that case, New Zealand's format protocol for bank account numbers may be identified by the protocol identifier 522. Alternatively, the other input field may be a drop-down field with a selectable list of options, where each option is associated with one of the plurality of format protocols. In that case, the protocol identifier 522 may have instructions to the processor 310 to receive a drop-down selection and to identify the format protocol associated with the selection. In the payment transfer example, each of the drop-down options may be associated with a particular country. Thus, if the New Zealand drop-down option is selected, the protocol identifier 522 has instructions to the processor 310 to identify the format protocol (for bank account numbers) associated with New Zealand. Other forms of input for the other input field may be used. As well, the format protocols may be associated with other categories or classifications, rather than by country, such as by credit card type etc.

In other implementations, rather than receiving another input from another input field, the protocol identifier 522 may have instructions to the processor 310 to identify the applicable format protocol in an alternate way, such as be receiving an indication from the web server hosting the host platform 500.

The format protocol engine 520 further comprises instructions to the processor 310 to determine whether the transfer input, such as the transfer text input, complies with the format protocol identified by the protocol identifier 522. To that end, the format protocol engine 520 may be or may use a trained machine learning model to do so. In the example embodiments, the host platform 500 may include one or more trained machine learning models 540 which are capable of receiving inputs and generating outputs in response. The trained machine learning model(s) 540 may be held by the host platform 500 within a model repository or held and accessed remotely from a cloud.

The trained machine learning model(s) 540 have been trained to determine whether the transfer (text) input (inputted into the input field) complies with the format protocol (identified by the protocol identifier 522). To that end, the format protocol engine 520 may be or may be configured to access, for example, a trained neural network, a trained deep neural network (DNN), a trained convolutional neural network (CNN), or a recurrent neural network (RNN). At least one of the trained machine learning model(s) 540 may have been trained using a training dataset of past or potential transfer inputs that have been labelled with ground-truth labels of its relevant format protocol and whether the transfer input complies.

The trained machine learning model(s) 540 may further be trained to identify one or more aspects of the transfer input that does/do not comply with the identified format protocol. To that end, one or more of the trained machine learning models 540 may be trained using a training dataset of past or potential transfer inputs that have been labelled with ground-truth labels of its associated or identified format protocol, and which aspects of the transfer input do not comply. When the transfer inputs are transfer text input, for example, the one or more aspects of the transfer text input that do not comply with the identified format protocol may include aspects such as the transfer input having the wrong number of required characters, a particular character is entered as a number when it should be a letter or a non-alphanumeric character (or vice versa), a required subseries of characters are placed in the wrong position in the series, certain characters are grouped in the wrong arrangement etc.

In some implementations, a separate trained machine learning model may be trained and used to determine whether the transfer input complies with the format protocol, and another (one or more) trained machine learning models may be trained and used to identify which aspects of the transfer input do not comply with the associated format protocol. In other implementations, the same trained machine learning model may be trained and used to perform all of the above-noted functions.

If it is determined that the transfer input does not comply with the format protocol, the format protocol engine 520 may further comprise instructions to the processor 310 to obtain an output explaining why or how the one or more aspects of the transfer input do not comply with the associated format protocol. As noted above, for transfer input in text form, why/how the one or more aspects of the transfer input do not comply may include the transfer input having the wrong number of required characters, a particular character is entered as a number when it should be a letter or a non-alphanumeric character (or vice versa), a required subseries of characters are placed in the wrong position in the series, certain characters are grouped in the wrong arrangement etc.

To that end, the format protocol engine 520 may use a trained machine learning model, such as a generative artificial intelligence (GenAI) model, to do so. In the example embodiments, the trained machine learning models 540 may be or may include a GenAI model 542, which is capable of receiving inputs (such as prompts) and generating outputs in response to the prompts. A prompt is typically understood to be a natural language input that includes instructions to the GenAI model to generate a desired output. The GenAI model 542 may be held by the host platform 500 within the model repository as one of the trained models 540, or held and accessed remotely from a cloud.

The GenAI model 542 may be a large language model (LLM) that uses natural language processing techniques to generate the output explaining why the one or more aspects of the transfer input do not comply with the associated format protocol. While the machine trained models described above may be specifically trained to transcribe an audio input, to determine whether the transfer (text) input complies with the corresponding format protocol, and/or to identify which aspects of the transfer (text) input do not comply, those (and other) functions may also be performed by a refined or specifically trained foundational model, such as the trained GenAI model 542.

According to various embodiments, the GenAI model 542 may be an LLM, such as a multimodal large language model. As another example, the GenAI model 542 may be a transformer neural network (“transformer”) or the like. A language model may use a neural network (typically a DNN) to perform natural language processing (NLP) tasks such as language translation, image captioning, grammatical error correction and natural language generation, among others. A language model may be trained to learn parameters in order to model how words relate to each other in a textual sequence, based on probabilities. A language model may contain hundreds of thousands of learned parameters or, in the case of an LLM, may contain millions or billions of learned parameters or more. In that manner, the GenAI model 542 can learn the patterns and structure of their input training data and then generate new content that has similar characteristics.

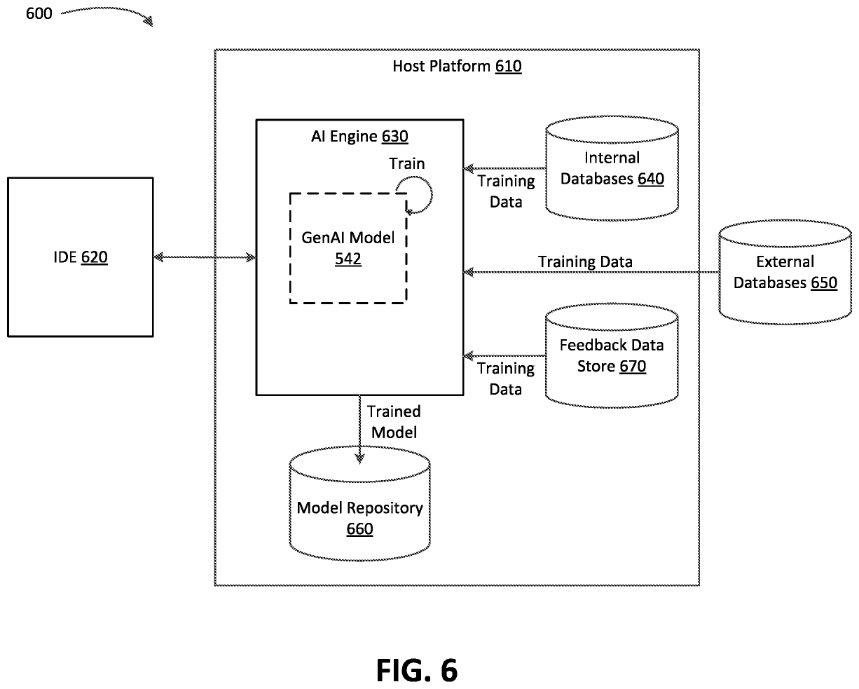

FIG. 6 schematically illustrates a process 600 of training the parameters of the GenAI model 542 according to example embodiments. However, it should be appreciated that the process 600 is also applicable to other types of models, such as other machine learning models, AI models, and the like. Referring to FIG. 6, a host platform 610 may host an IDE 620 (integrated development environment) where GenAI models, machine learning models, AI models, and the like may be developed, trained, retrained, and the like. In this example, the IDE 620 may include a software application with a user interface accessible by a user device over a network or through a local connection.

For example, the IDE 620 may be embodied as a web application that can be accessed at a network address, URL, etc., by a device. As another example, the IDE 620 may be locally or remotely installed on a computing device used by a user.

The IDE 620 may be used to design a model (via a user interface of the IDE), such as a generative artificial intelligence model that can receive transfer information and its appliable format protocol as input and generate output explaining or listing which aspects of the transfer information do not comply with the corresponding format protocol. The model can then be executed/trained based on training data established via the user interface. During training, the GenAI model 542 may be executed on training data via an AI engine 630 of the host platform 610.

The GenAI model 542 may be trained to understand various format protocols, including their specific rules or requirements, the classifications associated with the format protocols, natural language conversations, and the like based on a large corpus of documentation. The training data may be provided from a training data store such as an internal database 640, which may include training samples from the web, from customers, and the like. Additionally or alternatively, the training data may be pulled from one or more external databases 650 such as publicly available sites, etc.

In some implementations, the GenAI model 542 may also be trained with past or potential transfer inputs that have been labelled with ground-truth labels of its associated format protocol, and which aspects of the transfer input do not comply. The GenAI model 542 may also be trained with documents and web pages relating to the format protocols, related institutional sources, data from forum discussions, Q&A platforms, and other data sources that provide insight into the format protocols. In examples relating to payment transfers, where the format protocols relate to bank account numbers of financial institutions, the GenAI model 542 may also be trained with banking regulation document, web pages of the financial institution, and payment transfer manuals. The GenAI model 532 may also be trained with content gathered by web page scrapers or crawlers from website pages comprising payment transfer best practices, recommendations, and frequently asked question (FAQ) resources, and/or to fetch them from repositories or storage.

In some embodiments, the payload of data may be in a format that is not capable of being input to the GenAI model 542 nor read by a computer processor. For example, the payload of data may be in text format, image format, audio format, and the like. In response, the AI engine 630 may convert the payload of data into a format that is readable by the GenAI model 542, such as a vector or other encoding. The vector may then be input to the GenAI model 542.

The AI engine 630 may iteratively retrieve additional training data sets from the internal and external databases 640, 650 and iteratively input the additional training data sets into the GenAI model 542 during the execution of the model to continue to train the model. The AI engine 630 may continue the process until it receives instructions to terminate, which may be based on a number of iterations (training loops), total time elapsed during the training process, etc.

When the GenAI model 542 is sufficiently trained, it may be stored within a model repository 660 as one of the trained models 540 via the IDE 620 or the like.

The IDE 620 may also be used to retrain the GenAI model 542 after the model has been deployed. Here, the training process may use executional results that have already been generated or output by the GenAI model 542 in a live environment (including any user feedback, etc.) to retrain the GenAI model 542. For example, output that are generated by the GenAI model 542 and the user feedback of the output may be used to retrain the model to further enhance the responses that are generated for all users. The feedback may include indications of whether the generated output contributed towards a successful data transfer, was liked, and/or was relevant to the data transfer, and, if not, what aspects of the output were incorrect. This feedback data may be captured and stored within a feedback data store 670 or other data store within the live environment and can be subsequently used to retrain the GenAI model 542.

Returning to FIG. 5, the format protocol engine 520 comprises instructions to the processor 310 to execute the trained GenAI model 542 to generate an output explaining why and/or how the one or more aspects of the transfer input do not comply with the associated format protocol.

According to various embodiments, to generate such an output, the GenAI model 542 may be executed using custom-defined prompts that may be designed to first determine whether the transfer input complies with the associated format protocol (identified by the protocol identifier 522), then to identify which aspects of the transfer input do not comply (if the transfer input is found not to comply), and then to generate output explaining or listing why/how the transfer input does not comply. In other embodiments, a separate prompt may be designed and inputted sequentially to perform each of those functions.

In the depicted embodiment, the format protocol engine 520 may comprise a prompt generator 524 for generating prompts to the GenAI model 542. Prompt engineering is the process of structing sentences (prompts) so that they are understood by the GenAI model. Part of the prompting process may include delays/waiting times that are intentionally included within the script such that the model has time to think/understand the input data.

The prompt generator 524 may comprise instructions to the processor 310 to generate a prompt to the GenAI model 542 that incorporates the transfer input and the identified format protocol to generate a number of different outputs.

As noted above, the prompt generator 524 may comprise instructions to the processor 310 to generate a prompt to the GenAI model 542 to generate output explaining or listing why/how the transfer input does not comply. For transfer input in text form, the output may then include, among other things, explanation that the transfer input has the wrong number of required characters, a particular character is entered as a number when it should be a letter or a non-alphanumeric character (or vice versa), a required subseries of characters are placed in the wrong position in the series, certain characters are grouped in the wrong arrangement etc.

Additionally or alternatively, the prompt generator 524 may comprise instructions to the processor 310 to generate a prompt to the GenAI model 542 to further generate output that provides one or more suggestions to the user regarding how the one or more aspects of the transfer (text) input may be modified to comply with the associated format protocol. For transfer input in text form, the one or more suggestions may include, among other things, adding or removing characters from the transfer input to satisfy the number of required characters (according to the associated format protocol), changing a particular number to a letter or non-alphanumeric character (or vice versa), moving or adding a required subseries of characters to the correct position in the series, regrouping characters into the correct arrangement etc.

The signal generator 530 comprise instructions to the processor 310 to generate a signal indicating whether the transfer input complies with the identified format protocol, and then to further transmit the signal to the user inputting the transfer input in real time prior to submission of the transfer (text) input or prior to execution of the data transfer attempt. In this manner, the user may be notified in real time, prior to the data transfer attempt, regarding whether the inputted transfer input is compliant with the associated format protocol, and consequently, whether the data transfer is likely to be successful.

In applications where the format protocol engine 520 comprises instructions to the processor 310 to identify the one or more aspects of the transfer input that do not comply with the format protocol, the non-compliant one or more aspects of the transfer input may be included in the signal that is generated and transmitted to the user. In applications where the format protocol engine 520 comprises instructions to the processor 310 to obtain an explanation regarding how/why the one or more aspects of the transfer input do not comply with the associated format protocol, and/or one or more suggestions regarding how the one or more aspects of the transfer (text) input may be modified to comply with the associated format protocol, the outputted explanation and/or suggestions may also be included in the signal that is generated and transmitted to the user. In this manner, the user may be provided corrective information in real time, prior to the data transfer attempt, as to how the inputted transfer input may be corrected to be compliant with the associated format protocol, and consequently, how to increase the likelihood of success for the data transfer.

The signal generator 530 may comprise instructions to the processor 310 to transmit the signal to the user inputting the transfer input in one of multiple ways. In some applications, if the signal comprises the compliance determination and/or the non-compliant one or more aspects of the transfer input, the signal may be transmitted to the user via the user interface, such as by being displayed on the graphical user interface on the display 210 of the client device 110. In this manner, the user may be notified in real time, prior to the data transfer attempt, regarding whether the inputted transfer input is compliant with the associated format protocol, and consequently, whether the data transfer is likely to be successful. In other applications, if the signal comprises longer content, such as the non-compliant one or more aspects of the transfer input, the explanation regarding how or why the one or more aspects of the transfer input do not comply with the associated format protocol and/or the suggestions regarding how the one or more aspects of the transfer input may be modified to comply with the associated format protocol, the signal may be transmitted to the user in an email, a chat message, or through another other messaging format.

In alternative applications, rather than the format protocol engine 520 and the signal generator 530 generating and providing the output in one stage, the output may be requested and provided to the user in multiple stages.

For example, the format protocol engine 520 may comprise instructions to the processor 310 to first determine only whether the transfer input complies with the format protocol identified by the protocol identifier 522. The signal generator 530 may then comprise instructions to the processor 310 to transmit the signal to the user via the graphical user interface on the display 210 of the client device 110. The format protocol engine 520 may further comprise instructions to the processor 310 to provide a selectable option to the user via the graphical user interface for whether the user wishes for further information regarding the non-compliance of the transfer input. Upon receiving an indication for the further information, the format protocol engine 520 may further comprise instructions to the processor 310 to identify and/or obtain the non-compliant one or more aspects of the transfer input, the explanation regarding how or why the one or more aspects of the transfer input do not comply with the associated format protocol and/or the suggestions regarding how the one or more aspects of the transfer input may be modified to comply with the associated format protocol, as described above. The signal generator 530 may then comprise instructions to the processor 310 to transmit the signal with the further output to the user inputting the transfer input as also described above.

The input monitoring module 510 may further comprise instructions for the processor 310 to receive modification to the transfer input in the input field prior to submission of the transfer input or prior to execution of the data transfer. By monitoring and determining whether the data transfer is likely to be successful based on the content and format of the transfer input, and notifying the user prior to the data transfer attempt, the present system and method may help to reduce the computing processing resources that would be required when, potentially multiple, transfers are attempted after a failed transfer.

The format protocol engine 520 may further have instructions to the processor 310 to ask for, and receive, feedback from the user about the explanation and/or suggestions via the user interface. As noted above, this feedback data may be captured and stored within the feedback data store 670 or other data store within the live environment and can be subsequently used to retrain the GenAI model 542. The retrained GenAI model may be stored in the memory 320 with the other trained models 540.

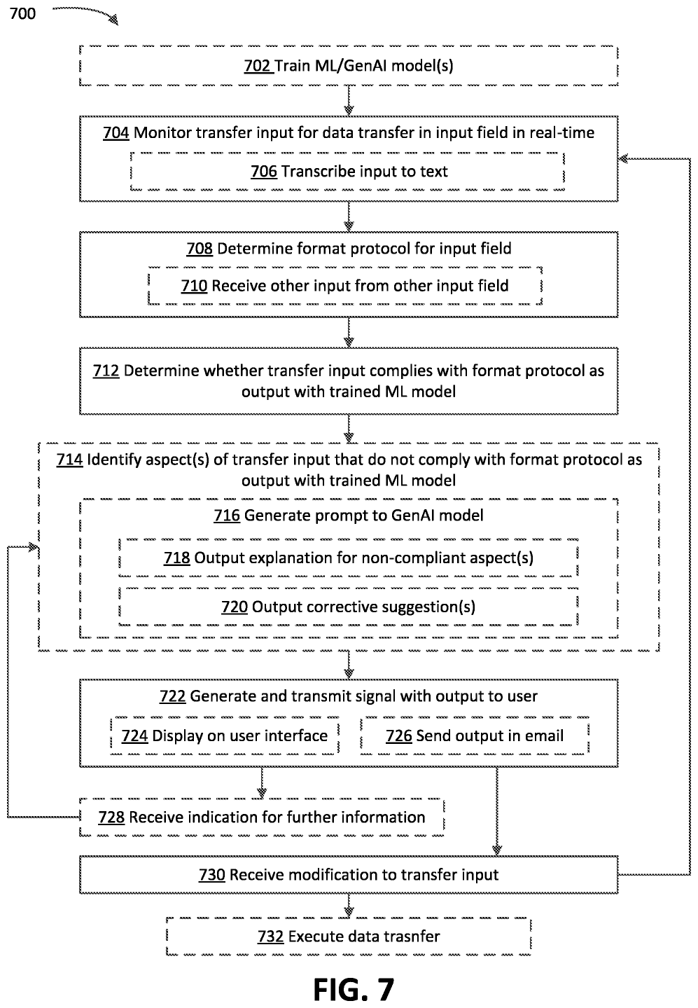

Reference will now be made to FIG. 7, which shows, in flowchart form, an example method 700 for pre-checking transfer input for data transfers based on the identified format protocol according to example embodiments. The method 700 may be implemented by way of suitably programmed processor-executable instructions stored in memory that, when executed, cause a computing device to carry out the described functions as described above. As other examples, the method 700 may be performed by another computing system, a software application, a server, a cloud platform, a combination of systems, and the like.

At operation 702, the method 700 may include training machine learning (ML) models (such as the trained models described above), which may be or may include a generative AI model (such as the GenAI model described above).

The GenAI model may be a new or existing foundational model refined or trained to understand format protocols, natural language conversations, and the like based on a large corpus of documentation. The training data may be provided from a training data store, which may include training samples from the web, from customers, and the like. Additionally or alternatively, the training data may be pulled from one or more external databases, such as publicly available sites, etc. In some implementations, the GenAI model may also be trained with documents and web pages relating to the format protocols, related institutional sources, data from forum discussions, Q&A platforms, and other data sources that provide insight into the format protocols. In examples relating to payment transfers, where the format protocols relate to bank account numbers of financial institutions, the GenAI model may also be trained with banking regulation document, web pages of the financial institution, and payment transfer manuals. The GenAI model may also be trained with content gathered by web page scrapers or crawlers from website pages comprising payment transfer best practices, recommendations, and frequently asked question (FAQ) resources, and/or to fetch them from repositories or storage. The customized GenAI model may then be stored (in memory).

Other trained machine learning models may also be stored in memory, including a speech-to-text model, machine learning models that has been trained to determine whether transfer input complies with a particular format protocol and/or to identify aspects of the transfer input that do not comply. These models may be a trained neural network, a trained deep neural network (DNN), a trained convolutional neural network (CNN), or a recurrent neural network (RNN). These machine learning models may be trained with past or potential transfer inputs that have been labelled with ground-truth labels of its associated format protocol, and which aspects of the transfer input do not comply.

At operation 704, transfer input for a data transfer that is inputted into an input field of a user interface is monitored in real time (such as by the input monitoring module described above). The input may include transfer information (including to whom and where the data is to be transferred) that is required to be submitted when transferring data. For example, if the data transfer is a payment transfer, the transfer input may include the recipient's name and bank details, including the recipient's bank account number. The transfer input may be inputted via the graphical user interface on the one or more displays of the client device. The transfer input may be inputted in text form, audio form, or another known forms of input. If the transfer input is not in text form, the non-text input may be converted into text form. For example, at operation 706, if the transfer input is in audio form, the transfer input may be transcribed into text. The transfer input may be transcribed using the transcriber as described above, which may be a speech-to-text application or machine learning model as known in the art that is configured to automatically convert the audio input into a text format in real time.

At operation 708, a format protocol that applies to the input field of the user interface is determined (such as by the protocol identifier described above). Format protocols are standards relating to the content, arrangement, and/or other formatting of the transfer input relating to the data transfer. For example, for transfer input in text form, the content, arrangement, and other formatting may include parameters such as the required number of characters, which characters must be numbers, if/where particular numbers must be positioned in the series, whether particular characters are letters or non-alphanumeric symbols, where certain characters are grouped in a particular arrangement etc. In applications involving payment transfers, a bank account number typically involves a long series of numbers, and possibly letters and other characters. Their content, arrangement, and other formatting are pre-established based on international banking regulations. Each country typically has one (or more) unique format protocols (i.e. format standards) for their bank account numbers that must be followed for payments to be transferred to a particular bank account in that country. Generally, the transfer information/input that is inputted must correctly follow its applicable format protocol for the data transfer to be successful. Otherwise, the data transfer may fail and not go through.

To determine the applicable format protocol, at operation 710, another input from another input field in the user interface may be received, where the other input indicates the applicable format protocol for the transfer input. The other input may be another text input or a selection from a drop-down menu that indicates which format protocol (from a plurality of format protocols) applies. In the payment transfer application example, each of the (plurality of) format protocols may be associated with a particular country. Thus, if “NZ”, “New Zealand”, or some variation is inputted into the other input field, or the New Zealand drop-down option is selected, the applicable format protocol for the transfer input (such as the bank account number) is determined to be that associated with New Zealand. Other forms of receiving the other input to determine the relevant format protocol may, alternatively, be used.

At operation 712, whether the transfer input complies with the identified format protocol is determined with one of the trained machine learning models (such as by using the format protocol engine described above). This determination may be considered the output of the machine learning model.

At operation 714, the method 700 may further include identifying one or more aspects of the transfer input that do not comply with the associated format protocol. The one or more aspect may further form part of the output from the trained machine learning model.

In some implementations, a separate trained machine learning model may be trained and used to determine whether the transfer input complies with the format protocol, and another (one or more) trained machine learning models may be trained and used to identify which aspects of the transfer input do not comply with the associated format protocol. In other implementations, the same trained machine learning model may be trained and used to perform all of the above-noted functions, such as the Gen AI model.

If it is determined that the transfer input does not comply with the relevant format protocol, the method 700 may further include, at operation 716, generating a prompt to the GenAI model. A prompt is typically understood to be a natural language input that includes instructions to the GenAI model to generate a desired output. At operation 718, the desired output may be an explanation for why or how the one or more aspects of the transfer input do not comply with the associated format protocol. As noted above, for transfer input in text form, the why or how may include the transfer input having the wrong number of required characters, a particular character is entered as a number when it should be a letter or a non-alphanumeric character (or vice versa), a required subseries of characters are placed in the wrong position in the series, certain characters are grouped in the wrong arrangement etc. At operation 720, the desired output may be one or more suggestions for how the user may modify and correct the transfer input in order to bring it into compliance with the associated format protocol.

At operation 722, a signal may be generated and transmitted (such as by the signal generator described above) to the user inputting the transfer input in real time, where the signal incorporates the output from the trained machine learning models or GenAI model. If the signal comprises the compliance determination and/or the non-compliant one or more aspects of the transfer input, the signal may be transmitted to the user via the user interface, such as be being displayed on the graphical user interface on the display of the client device (at operation 724). In other applications, if the signal comprises longer content, such as the non-compliant one or more aspects of the transfer input, the explanation regarding how or why the one or more aspects of the transfer input do not comply with the associated format protocol and/or the suggestions regarding how the one or more aspects of the transfer input may be modified to comply with the associated format protocol, the signal may be transmitted to the user as an email (at operation 726), a chat message, or through another other messaging format.

In applications where only short feedback is initially provided to the user, such as only whether the transfer input complies with the identified format protocol is determined, at operation 728, a selectable option to the user may be provided via the graphical user interface for whether the user wishes for further information regarding the non-compliance of the transfer input. Upon receiving an indication for the further information, the method 700 may return to operation 714 to identify and/or obtain the non-compliant one or more aspects of the transfer input, the explanation regarding how or why the one or more aspects of the transfer input do not comply with the associated format protocol and/or the suggestions regarding how the one or more aspects of the transfer input may be modified to comply with the associated format protocol, as described above. Then at operation 722, the signal with the further output may be generated and transmitted to the user associated with the transfer input via email, for example.

At operation 730, the method 700 further includes receiving modification to the transfer input in the input field prior to submission of the input or prior to execution of the data transfer. At that point, the process may further return to operation 704, and the method 700 may be repeated iteratively until the user is satisfied with the transfer input and/or attempts the execute the data transfer (at operation 732).

By monitoring and determining whether the data transfer is likely to be successful based on the content and format of the transfer input, and notifying the user prior to the data transfer attempt, the present system and method may help to reduce the computing processing resources that would be required when, potentially multiple, transfers are attempted after a failed transfer.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system, comprising:
a processor;
a communications module coupled to the processor; and
a memory coupled to the processor, the memory storing instructions that, when executed, configure the processor to:
monitor input of transfer input for a data transfer in an input field of an interface displayed on a device in real-time;
determine a format protocol that applies to the input field;
determine whether the transfer input complies with the format protocol using a trained machine learning model;
generate and transmit a signal to the device receiving the transfer input in real time, the signal indicating whether the transfer input complies with the format protocol; and
receive modification to the transfer input in the input field prior to execution of the data transfer.

2. The system of claim 1, wherein the transfer input is a transfer text input or the instructions, when executed, further configure the processor to convert the transfer input into a transfer text input.

3. The system of claim 2, wherein the instructions, when executed, further configure the processor to:
identify one or more aspects of the transfer text input that do not comply with the format protocol using the trained machine learning model;
wherein the signal incorporates the one or more aspects of the transfer text input that do not comply with the format protocol.

4. The system of claim 3, wherein the format protocol relates to aspects of the transfer text input including a required number of characters in the transfer text input, and whether each character is a letter, a number, or a non-alphanumeric symbol.

5. The system of claim 4, wherein the instructions, when executed, further configure the processor to determine the format protocol that applies to the input field by:
receiving another input from another input field of the interface displayed on the device, the other input indicating the format protocol.

6. The system of claim 5, wherein the format protocol is determined from a plurality of format protocols.

7. The system of claim 6, wherein each format protocol of the plurality of format protocols is associated with a country, and the instructions, when executed, further configure the processor to determine the format protocol by determining the country the other input is affiliated with.

8. The system of claim 4, wherein the trained machine learning model is a generative artificial intelligence (GenAI) model.

9. The system of claim 8, wherein the instructions, when executed, further configure the processor, upon execution of the GenAI model, to obtain an output explaining why the one or more aspects of the transfer text input do not comply with the format protocol; wherein the signal includes the output.

10. The system of claim 9, wherein the GenAI model is a large language model (LLM), and the output further comprises one or more suggestions of how the one or more aspects of the transfer text input may be modified to help comply with the format protocol.

11. The system of claim 9, wherein the instructions, when executed, further configure the processor to transmit the signal with the output to the device via an email.

12. The system of claim 8, wherein the instructions, when executed, further configure the processor to:
receive an indication for further information regarding the one or more aspects of the transfer text input that do not comply with the format protocol;
obtain, upon execution of the GenAI model, an output explaining why the one or more aspects of the transfer text input do not comply with the format protocol; and
transmit the output to the device in response to the indication.

13. A method comprising:
monitoring input of transfer input for a data transfer in an input field of an interface displayed on a device in real-time;
determining a format protocol that applies to the input field;
determining whether the transfer input complies with the format protocol using a trained machine learning model;
generating and transmitting a signal to a the device receiving the transfer input in real time, the signal indicating whether the transfer input complies with the format protocol; and
receiving modification to the transfer input in the input field prior to execution of the data transfer.

14. The method of claim 13, further comprising:
identifying one or more aspects of the transfer input that do not comply with the format protocol using the trained machine learning model;
wherein the signal incorporates the one or more aspects of the transfer input that do not comply with the format protocol.

15. The method of claim 14, wherein the transfer input is transfer text input and the format protocol relates to aspects of the transfer text input including a required number of characters in the transfer text input, and whether each character is a letter, a number, or a non-alphanumeric symbol.

16. The method of claim 14, wherein determining the format protocol that applies to the input field comprises:
receiving another input from another input field of the interface displayed on the device, the other input indicating the format protocol.

17. The method of claim 14, wherein the trained machine learning model is a generative artificial intelligence (GenAI) model.

18. The method of claim 17, further comprising:
upon execution of the GenAI model, obtaining an output explaining why the one or more aspects of the transfer input do not comply with the format protocol;
wherein the signal includes the output.

19. The method of claim 17, further comprising:
upon execution of the GenAI model, obtaining an output comprising one or more suggestions of how the one or more aspects of the transfer input may be modified to help comply with the format protocol.

20. A computer-readable medium comprising instructions stored therein which, when executed by a processor, cause a computer to:
monitor input of transfer input for a data transfer in an input field of an interface displayed on a device in real-time;
determine a format protocol that applies to the input field;
determine whether the transfer input complies with the format protocol using a trained machine learning model;
generate and transmit a signal to a the device receiving the transfer input in real time, the signal indicating whether the transfer input complies with the format protocol; and
receive modification to the transfer input in the input field prior to execution of the data transfer.
